(19) United States
(12) Patent Application Publication
(10) Pub. No.: US 2003/0111118 A1
(43) Pub. Date: Jun. 19, 2003

(54) Color changers

(76) Inventor: Michael J. Diana, Orion, MI (US)

Correspondence Address: BARNES & THORNBURG, 11 South Meridian Street, Indianapolis, IN, 46204, US

(21) Appl. No.: 10/022,494

(22) Filed: Dec. 17, 2001

(51) Int. Cl. F16K 11/10

(52) U.S. Cl. 137/606

(57) ABSTRACT

A color changer includes a first passageway and a second passageway. A valve is coupled to the first passageway and the second passageway to control color flow between the first and second passageways. The first passageway is adapted to permit the passage of a color-conserving pig through the first passageway.

### FIELD OF THE INVENTION

This invention relates to systems for changing the type, for example, the color, of a fluid material that is being transported through a fluid delivery system. It is disclosed in the context of a color changer for a coating material dispensing system, but is believed to have applications in other fields as well.

### BACKGROUND OF THE INVENTION

Coating material application systems, including systems for the application of selected different colors of coating materials under the control of a coating application system controller or under manual control, are well known. There are, for example, the systems illustrated and described in the following U.S. patents, and references cited in these U.S. Pat. No. 4,159,806; 4,311,724; 4,348,425; 4,350,720; 4,356,868; 4,403,736; 4,592,305; 5,058,812; 5,318,065; 5,632,816; 5,725,150; and, Re. 32,151. The disclosures of these references are hereby incorporated herein by reference. No representation is intended by this listing that a complete search of all the relevant prior art has been conducted, or that no better art than that listed is available, or that the listed art is relevant. Nor should any such representation be inferred.

The coating materials in use in such systems have become increasingly expensive as coating material technology has developed, for example, in response to environmental considerations, safety considerations and the like. In coating material dispensing systems in which any one of a number of different coating materials, in some cases up to one hundred different colors or more, can be dispensed virtually on demand, the amount of coating material circulating in such systems at any given time can be appreciable. Additionally, whenever it is desired to change from coating with one coating material (hereinafter sometimes the pre-change color) to coating with another coating material (hereinafter sometimes the post-change color), there is inevitably some quantity of coating material of the pre-change color left in the dispensing system which must be purged from the dispensing system to, for example, waste container, in order to prevent cross-contamination with the pre-change color of the article(s) to be coated with the post-change color.

Various solutions have been proposed for, among other objectives, reducing the waste of coating material during such color change operations. See, for example, above identified U.S. Pat. Re. No. 32,151. Typically, coating materials of these types are continuously circulated in fluid circuits, for example, to prevent settling of pigments or setting up of the coating material. When it is desired to coat with one of such coating materials, a valve coupled through relatively short length of tubing to the color change system is opened, shunting the necessary amount of the material from the circuit in which it continuously circulates through the color change system to the dispensing apparatus.

The use of pigs which circulate in fluid circuits is known. A description of the use of pigs can be found in, for example, John Nehrbass, “If You Don't Have One Already, You Would Do Well To Consider A Pigging Program Implemented On A Regular Basis,” Flow Control, vol 7, no. 10, pp. 35-38, October, 2001. The disclosure of this reference is hereby incorporated herein by reference. No representation is intended by this listing that a complete search of all the relevant prior art has been conducted, or that no better art than that listed is available, or that the listed art is relevant. Nor should any such representation be inferred.

### DISCLOSURE OF THE INVENTION

According to the invention, a fluid changer includes a first passageway and a second passageway. A valve is coupled between the first and second passageways. The valve controls the flow of the fluid from the first passageway to the second passageway and out of the fluid changer. The first passageway is adapted to permit the passage of a pig therethrough.

Illustratively, the fluid changer is modular. Each fluid changer module includes a first passageway and a second passageway. Each module further includes a valve coupled to that module's first passageway. Each valve permits the fluid that flows through that module's first passageway to be provided to that module's second passageway upon actuation of that module's valve, and out of the fluid changer. Each module's first passageway is adapted to permit the passage of a pig therethrough.

Further illustratively, a circuit supplies the fluid to fluid dispensing device. Each valve, when actuated, provides the fluid that flows through its respective module's second passageway and out of the fluid changer to the circuit and the dispensing device.

Additionally illustratively, the apparatus includes a pressure regulator. The pressure regulator is oriented in the circuit between the fluid changer and the dispensing device.

Illustratively, the modules are selectively removably connectable together in a desired number to permit the selection of any of a desired number of fluids in the fluid changer.

Further illustratively, each module includes two second passageways and two valves, one valve coupled between that module's first passageway and each of its second passageways. Each valve controls fluid flow between its module's first passageway and its respective second passageway and out of the fluid changer.

Illustratively, two circuits supply the fluids transported through the two second passageways to two fluid dispensing devices. Each valve, when actuated, provides the fluid that flows through its respective one of its respective module's second passageways out of the fluid changer to a respective one of the circuits and a respective dispensing device.

Further illustratively, each of the two circuits includes a pressure regulator oriented between the fluid changer and that circuit's respective dispensing device.

Additionally illustratively, the circuit includes valve means for switching between supplying the fluids transported through the two second passageways to a single fluid dispensing device. Each valve, when actuated, provides the fluid that flows through its respective one of the second passageways to the dispensing device.

Further illustratively, the circuit includes a pressure regulator oriented in the circuit between the valve means and the dispensing device.

Illustratively, the fluid changer includes a coating material color changer for selecting among a number of colors of coating material to be supplied to an output port of the color changer.

### BRIEF DESCRIPTION OF THE DRAWINGS

The invention may best be understood by referring to the following detailed description and accompanying drawings which illustrate the invention. In the drawings:

FIG. 1 illustrates a perspective view of a module of a color changer for use in a coating material dispensing system constructed according to the invention;

FIG. 2 illustrates a plan view of the module illustrated in FIG. 1;

FIG. 3 illustrates a sectional view of the module illustrated in FIGS. 1-2, taken generally along section lines 3-3 of FIG. 2;

FIG. 4 illustrates a sectional view of the module illustrated in FIGS. 1-3, taken generally along section lines 4-4 of FIG. 2;

FIG. 5 illustrates an elevational view of the module illustrated in FIGS. 1-4, taken generally along section lines 5-5 of FIG. 2;

FIG. 6 illustrates an elevational view of the module illustrated in FIGS. 1-5, taken generally along section lines 6-6 of FIG. 2;

FIG. 7 illustrates a diagrammatic view of a coating material dispensing system incorporating a color changer module of the type illustrated in FIGS. 1-6;

FIG. 8 illustrates a diagrammatic view of another coating material dispensing system incorporating a color changer constructed according to the invention;

FIG. 9 illustrates a diagrammatic view of another coating material dispensing system incorporating a color changer constructed according to the invention; and,

FIGS. 10 and 11 illustrate fragmentary perspective views of two color changers constructed according to the invention.

### DETAILED DESCRIPTIONS OF ILLUSTRATIVE EMBODIMENTS

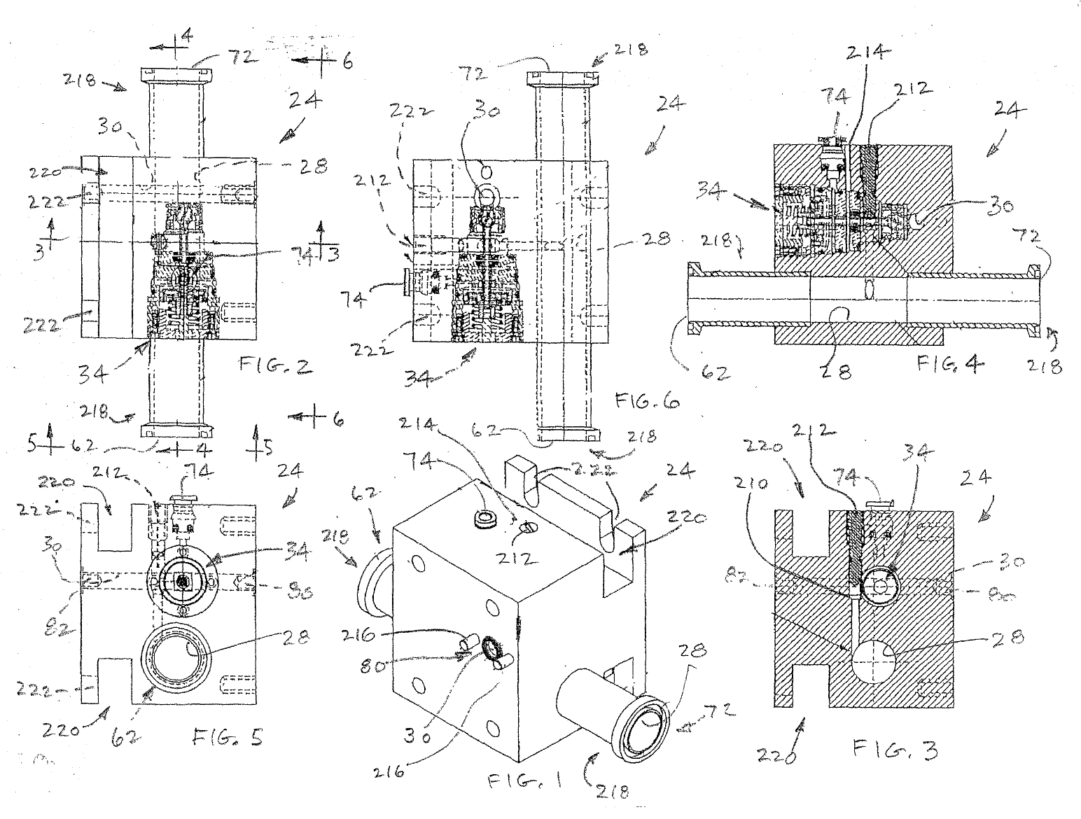

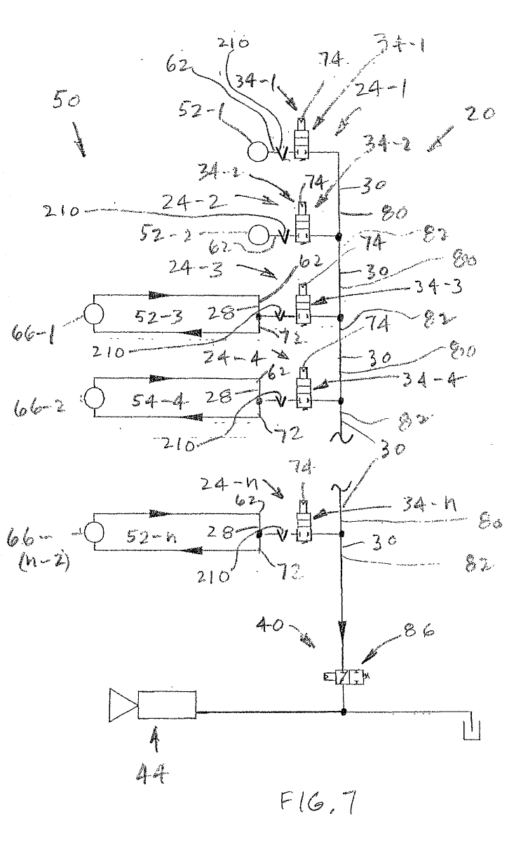

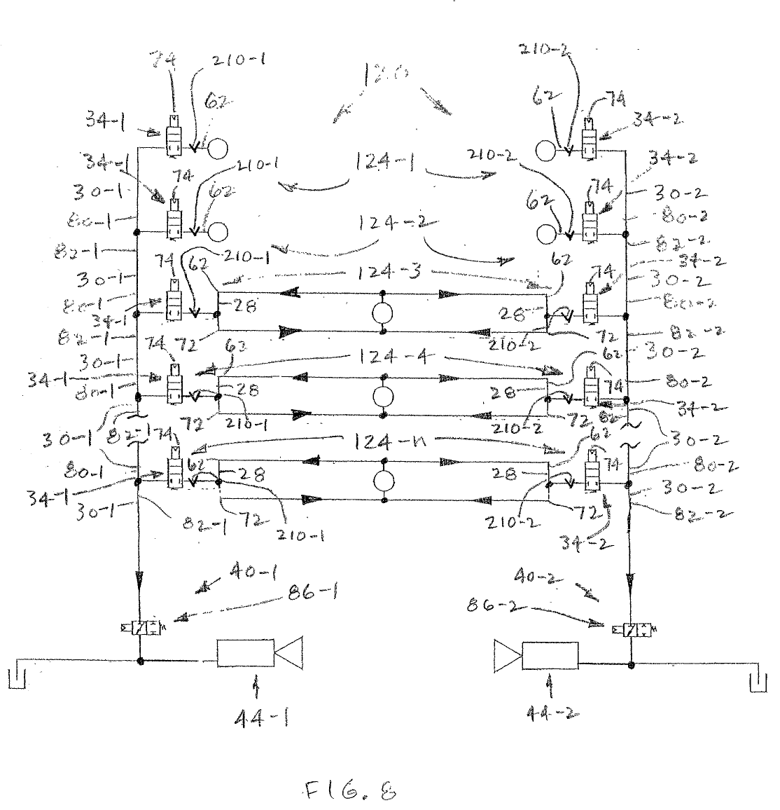

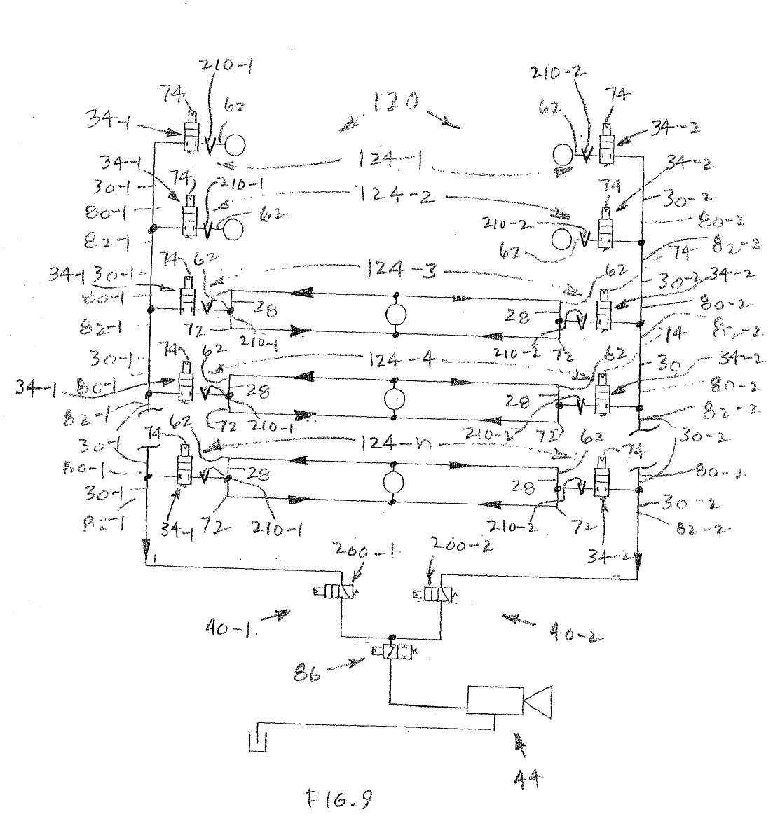

Referring now to FIGS. 1-7, a color changer 20 includes multiple, modular, interconnectable color changer valve blocks 24-1, 24-2, . . . 24-n, each including a first through passageway 28 and a second through passageway 30. A respective valve 34 is coupled to each first through passageway 28. Each valve 34 permits the fluid that flows through the first passageway 28 to be provided to that module 24's second through passageway 30 upon actuation of that valve 34, and thus to a circuit 40 for supplying the fluid to subsequent equipment 44, such as coating material dispensing equipment, associated with fluid supply circuit 40. The valves 34 may be, for example, the type illustrated and described in U.S. patent application Ser. No. ______, titled MODULAR FLUID PRESSURE REGULATOR WITH BYPASS, invented by Michael J. Diana and David L. Hamilton and assigned to the same assignee as this application. The disclosure of Ser. No. ______ is hereby incorporated herein by reference.

A one-color, color change circuit 50 includes a modular color changer 20 according to the invention. A source 52-1, 52-2, . . . 52-n for each fluid to be supplied to the modular color changer 20, in this case, compressed air, solvent, color 1, color 2, . . . and color (n−2), is coupled to an input port 62 of a respective module 24-1, 24-2, . . . 24-n. In the case of compressed air, the source 52-1 is, for example, regulated factory compressed air. In the case of solvent, the source 52-2 is a source of pressure-regulated solvent. In the cases of colors 1—(n−2), the sources 52-3, 52-4, . . . 52-n, respectively, are color 1, color 2, . . . and color (n−2) circuits through which colors 1, 2, . . . and (n−2) circulate continuously under the control of respective pumps 66-1, 66-2, . . . 66-(n−2).

As previously noted, continuous circulation is maintained, for example, to prevent settling of pigment from color 1, 2, . . . (n−2), or setting up of color 1, 2, . . . (n−2), or for any of a number of other reasons known in the art. The solvent may, but typically will not, circulate in a circuit external to its module 24-2. Nor will the compressed air. Thus, in the case of each of compressed air and solvent, only an input port 62 need be provided for its respective service. However, for each of the colors 1, 2, . . . (n−2), an input port 62 and an output port 72 are provided. In each module 24, a valve 34 controls the supply of its respective fluid to the fluid supply circuit. Each valve 34 is controlled by a control signal supplied to a control port 74 provided on that valve 34's respective module 24. The control ports 74 are coupled by separate control lines (not shown) to, for example, compressed air signal sources (not shown).

Each module 24 except the one 24-1 at the end of the changer remote from the dispensing equipment 44 (in this and most cases the compressed air module 24-1), includes a second through passageway 30 having an input port 80 and an output port 82. This second through passageway 30 serves as a pass-through for the selected fluid unless the fluid controlled by its respective module 24 is the selected fluid. Then, its valve 34 is actuated, providing communication between its first and second through passageways 28, 30 and permitting the fluid controlled by its respective valve 34 to pass from its first passageway 28 to its second passageway 30 and out through the output port 82 of its second through passageway 30. Appropriate O-ring seals are provided around the joined output ports 82 and input ports 80 of adjacent modules 24 to minimize leakage of coating material therebetween.

Downstream in the fluid supply circuit 40 between the output port 82 of the last module 24-n in the series, the fluid supply circuit 40 includes a pressure regulator 86 to ensure that the fluid supplied to the dispensing equipment 44, whether that fluid be solvent, color 1, color 2, . . . or color (n−2), is supplied to the dispensing equipment at a pressure controlled by the pressure regulator 86. The output of the fluid pressure regulator 86 flows through another valve (not shown) typically internal to the dispensing equipment 44 and is dispensed by the dispensing equipment 44. When this valve is not open, none of the color modules 24s' valves 34 are typically open. Fluid pressure regulator 86 may be, for example, one of the type illustrated and described in U.S. Ser. N. ______.

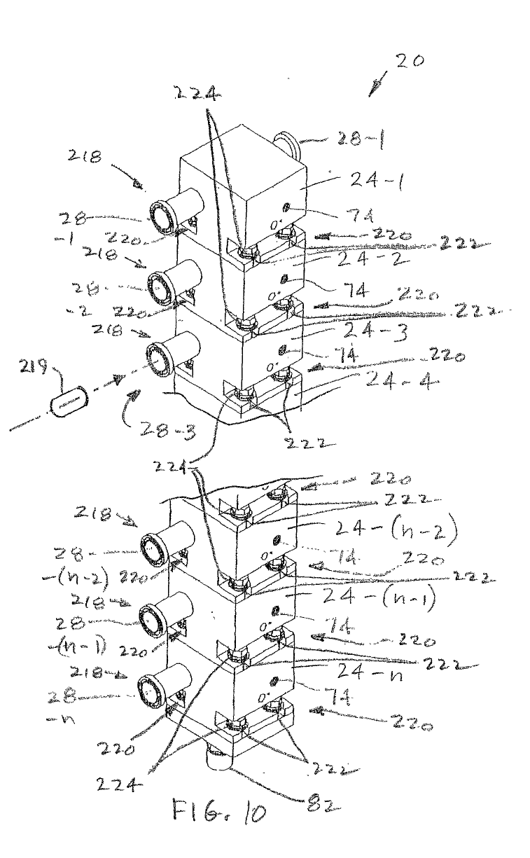

In another embodiment of the invention illustrated in FIG. 8, each module 124 (again, excepting the module 124-1 at the end of the changer 120 remote from the dispensing equipment 44) includes two parallel second through passageways 30-1 and 30-2, each having an input port 80-1, 80-2, respectively, and an output port 82-1, 82-2, respectively. Each second through passageway 30-1, 30-2 serves as a pass-through for a fluid selected from among the fluids controlled by the various modules 124, again, unless one or both of the selected fluids is (are) the fluid controlled by that module 124's respective valve(s) 34-1 and (or) 34-2. Then, that module 124's valve(s) 34-1 and (or) 34-2 is (are) actuated, providing communication between its first passageway 28 and the selected one or both of the second through passageways 30-1, 30-2.

The selected fluid(s) then pass(es) out of the color changer 120 through the output port(s) 82-1 and (or) 82-2 of the second through passageway(s) 30-1 and (or) 30-2 of the most downstream module 124-n in the color changer 120. Again, downstream in the fluid supply circuits 40-1, 40-2 between the output ports 82-1, 82-2 of the last module 124-n in the series, the fluid supply circuits 40-1, 40-2 include pressure regulators 86-1, 86-2 to ensure that the fluids supplied to the dispensing equipment 44-1, 44-2, whether they be solvent, color 1, color 2, . . . or color (n−2), are supplied to the dispensing equipment 44-1, 44-2 at pressures controlled by the pressure regulators 86-1, 86-2. The outputs of the fluid pressure regulators 86-1, 86-2 flow through other valves (not shown) typically internal to the dispensing equipment 44-1, 44-2 and are dispensed by the dispensing equipment 44-1, 44-2. When these valves are not open, none of the color modules 124s' valves 34 are typically open.

Another fluid circuit incorporating a color changer 120 is illustrated in FIG. 9. In this embodiment, each module 124 (again, excepting the one at the end of the changer 120 remote from the dispensing equipment 44) includes two second through passageways 30-1 and 30-2, each having an input port 80 and an output port 82. Each second through passageway 30-1, 30-2 serves as a pass-through for a fluid selected from among the fluids controlled by the various modules 124, unless one or both of the selected fluids is (are) the fluid controlled by that module 124's respective valve(s) 34-1 and (or) 34-2. Then, that module 124's valve(s) 34-1 and (or) 34-2 is (are) actuated, providing communication between its first passageway 28 and the selected one or both of the second through passageways 30-1, 30-2.

The selected fluid(s) then pass(es) out of the color changer 120 through the output port(s) 82-1 and (or) 82-2 of the second through passageway(s) 30-1 and (or) 30-2. Downstream in the fluid supply circuits 40-1, 40-2 between the output ports 82-1, 82-2 of the last module 124 in the series (here, the color (n−2) module), the fluid supply circuits 40-1, 40-2 include selector valves 200-1, 200-2, respectively, which are separately operable to provide either the fluid flowing in second through passageway 30-1 or the fluid flowing in second through passageway 30-2 to a pressure regulator 86 to ensure that the fluid supplied to the dispensing equipment 44, whether it be solvent, color 1, color 2, . . . or color (n−2), is supplied to the dispensing equipment 44 at a pressure controlled by the pressure regulator 86. The output of the fluid pressure regulator 86 flows through another valve (not shown) typically internal to the dispensing equipment 44 and is dispensed by the dispensing equipment 44.

When this valve is not open, none of the color modules 124s' valves 34 are typically open.

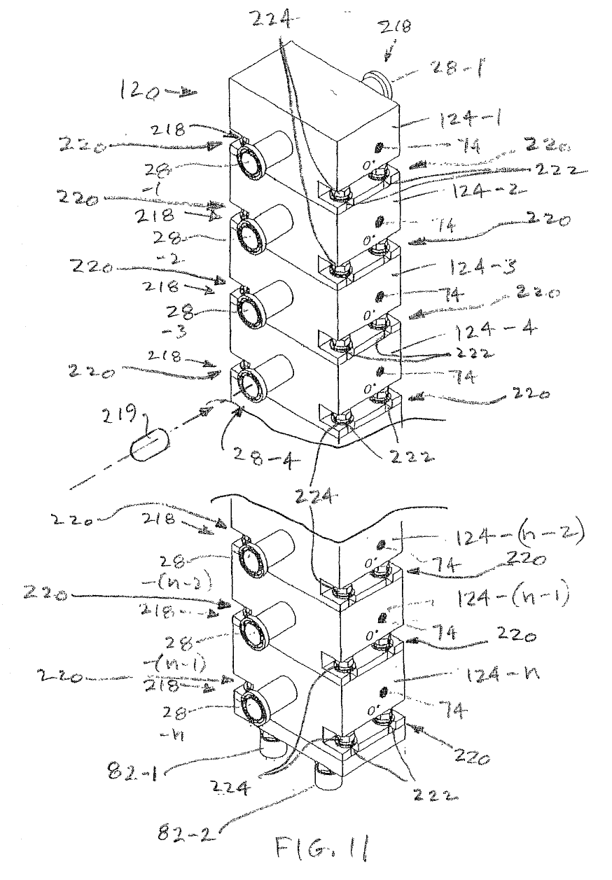

The construction of each individual module 24, 124, can further be appreciated by referring to FIGS. 1-6. Each module 24, 124 includes, in addition to its first through passageway 28 and one (in modules 24) or two (in modules 124) second through passageway(s) 30, 30-1, 30-2: one (in modules 24) or two (in modules 124) paint shutoff valve seat(s) 210, 210-1, 210-2; one (in modules 24) or two (in modules 124) manual paint shutoff valve closure(s) 212 which cooperate(s) with the paint shutoff valve seat(s) 210, 210-1, 210-2 to turn off the flow of fluid to that module 24's or 124's respective first through passageway 28; one (in modules 24) or two (in modules 124) valve(s) 34, 34-1, 34-2; one (in modules 24) or two (in modules 124) weep port(s) 214 in the location(s) and for the purpose(s) disclosed in U.S. Ser. N. ______ and, alignment pins 216 (shown only in FIG. 1). Alignment pins 216 aid in the alignment of the output port(s) 82, 82-1, 82-2 of each module 24, 124 upstream in the fluid circuit with the input port(s) 80, 80-1, 80-2 of a respective module 24, 124 downstream in the fluid circuit. Ports 62 and 72 are provided with sanitary fittings 218 to provide smooth, uniform interior dimensions in passageways 28 to ease the passage of (a) pig(s) 219 (FIGS. 10 and 11) through passageways 28 in order to recover undispensed amounts of the various colors, thereby minimizing the waste of colors which remain in the circuit after their respective dispensing cycles. Externally, the modules 24, 124 are configured with means such as, for example, grooves 220, slots 222 and complementarily located threaded holes, which permit modules 24, 124 to be assembled, using, for example, threaded fasteners 224, into a color changer 20, 120 “stack” including any desired number of modules 24, 124, corresponding to any desired number of colors.

It should be understood that other components, such as, for example, a flowmeter, may be included in the circuit 40, 40-1, 40-2, for example, on the output port 82 of the most downstream module 24-n, 124-n.

What is claimed is:

1. A fluid changer including a first passageway and a second passageway, a valve coupled to the first passageway, the valve permitting the fluid that flows through the first passageway to be provided to the second passageway upon actuation of the valve, and out of the fluid changer, the first passageway adapted to permit the passage of a pig through the first passageway.

2. The apparatus of claim 1 including sections, each section including a first passageway and a second passageway, each section further including a valve coupled to that section's first passageway, each valve permitting the fluid that flows through that section's first passageway to be provided to that section's second passageway upon actuation of that section's valve, and out of the fluid changer, each section's first passageway adapted to permit the passage of a pig through the first passageway.

3. The apparatus of claim 2 further including a circuit for supplying the fluid to fluid dispensing device, each valve providing the fluid that flows through its respective section's second passageway upon actuation of that section's valve, and out of the fluid changer to the circuit and the dispensing device.

4. The apparatus of claim 3 further including a pressure regulator, the pressure regulator oriented in the circuit between the fluid changer and the dispensing device.

5. The apparatus of claim 2 wherein each section comprises a separate module, the modules being selectively removably connectable together in a desired number to permit the selection of any of a desired number of fluids in the fluid changer.

6. The apparatus of claim 2 further including two second passageways, each section further including two valves coupled to that section's first passageway, each valve permitting the fluid that flows through that section's first passageway to be provided to a respective one of that section's second passageways upon actuation of that respective valve, and out of the fluid changer.

7. The apparatus of claim 6 further including two circuits for supplying the fluids transported through the two second passageways to two fluid dispensing devices, each valve providing the fluid that flows through its respective one of its respective section's second passageways upon actuation of that respective valve, and out of the fluid changer to a respective one of the circuits and to a respective dispensing device.

8. The apparatus of claim 7 further including a pressure regulator oriented in each circuit between the fluid changer and that circuit's respective dispensing device.

9. The apparatus of claim 6 further including valve means for switching between supplying the fluids transported through the two second passageways to the fluid dispensing device, the valve means providing the fluid that flows through a selected one of the second passageways to the dispensing device.

10. The apparatus of claim 9 further including a pressure regulator oriented in the circuit between the valve means and the dispensing device.

11. The apparatus of claim 2 wherein the fluid changer includes a coating material color changer for selecting among a number of colors of coating material to be supplied to an output port of the color changer.

12. The apparatus of claim 3 wherein each section comprises a separate module, the modules being selectively removably connectable together in a desired number to permit the selection of any of a desired number of fluids in the fluid changer.
